(19) United States
(12) Patent Application Publication
(10) Pub. No.: US 2019/0344560 A1
(43) Pub. Date: Nov. 14, 2019

(54) NOZZLE REPLACEMENT TO MINIMIZE VISUAL DISCONTINUITIES

(71) Applicant: Hewlett-Packard Development Company, L.P., Spring, TX (US)

(72) Inventors: Leslie Caroline Drogo, San Diego, CA (US); Ron Burns, San Diego, CA (US)

(73) Assignee: Hewlett-Packard Development Company, L.P., Spring, TX (US)

(21) Appl. No.: 16/464,703

(22) PCT Filed: Feb. 2, 2017
(86) PCT No.: PCT/US2017/016171

§ 371 Date: May 29, 2019

(51) Int. Cl. B41J 2/045

(52) U.S. Cl. CPC B41J 2/0451; B41J 2/125; B41J 2/04586

(57) ABSTRACT

In an example, a system is described that includes a plurality of nozzles, a vision system, a controller, and a fluid ejection array controller. The plurality of nozzles ejects fluid that creates an output. The vision system detects a visual discontinuity in the output. The vision system further identifies a faulty nozzle that is the source of the visual discontinuity. The controller selects an alternate nozzle to eject fluid in place of the faulty nozzle to minimize the visual discontinuity. The controller may also select a time at which the faulty nozzle ceases ejecting fluid and the alternate nozzle commences ejecting fluid in place of the faulty nozzle to minimize the visual discontinuity. The fluid ejection array controller controls ejection of fluid by the faulty nozzle and the alternate nozzle under instructions from the controller.

### BACKGROUND

Packaging web presses (or PWPs) are printing devices that may be used to print labels, folding cartons, flexible packaging, shrink sleeves, and other types of product packaging.

### BRIEF DESCRIPTION OF THE DRAWINGS

FIG. 1A illustrates a first example system of the present disclosure;

FIG. 1B illustrates a second example system of the present disclosure;

FIG. 2 illustrates a flowchart of an example method for correcting visual discontinuities in print outputs;

FIG. 3 illustrates a flowchart of another example method for correcting visual discontinuities in print outputs;

FIGS. 4A and 4B are block diagrams illustrating example masks that may be used to facilitate correction of visual discontinuities in print outputs; and

FIG. 5 depicts a high-level block diagram of an example computer that can be transformed into a machine capable of performing the functions described herein.

### DETAILED DESCRIPTION

The present disclosure broadly describes a system, method, and non-transitory computer-readable medium for correcting visual discontinuities in print outputs. As discussed above, a packaging web press (PWP) may be used to print various types of product packaging, including labels, folding cartons, flexible packaging, shrink sleeves, and other types of packaging. The PWP may simultaneously print one or more repeating images for the product packaging in distinct lanes of its output. For instance, the “web” or printing surface of the PWP may be divided into multiple “lanes” that run the length of the web. Each lane may further include multiple “ribbons” that run the width of the lane. The image corresponding to the packaging may be repeated across the ribbon (i.e., in the “cross-web” direction) and/or along the lane (i.e., in the “down-web” direction).

Although the same digital source image is used when repeating the image across a ribbon and along the lane, this does not necessarily mean that each printed copy of the image will look identical when printed. For instance, damage to or blockage of one or more nozzles of the PWP's fluid ejection devices (e.g., printheads, printbars, ink pens, or the like) can cause undesirable visual discontinuities such as voids in the print output.

Examples of the present disclosure exploit the availability of redundant nozzles in fluid ejection devices. That is, the fluid ejection devices of a PWP may include redundant nozzles, such that any particular dot of primary color fluid in the print output could be generated by more than one possible nozzle. Redundant nozzles may be used to maximize the speed of the PWP (e.g., by firing all of the nozzles in all of the fluid ejection devices simultaneously). However, redundant nozzles may also be used as backups when one or more nozzles of a fluid ejection device are unable to fire properly (e.g., due to damage or blockage). Examples of the present disclosure use the vision system of the PWP to identify a faulty nozzle that is responsible for creating a visual discontinuity (e.g., a void) in the print output. The disclosure further selects an alternate nozzle to fire in place of the faulty nozzle, and determines a time at which to switch from the faulty nozzle to the alternate nozzle to minimize further discontinuities in the print output and to make the transition from the faulty nozzle to the alternate nozzle as seamless as possible.

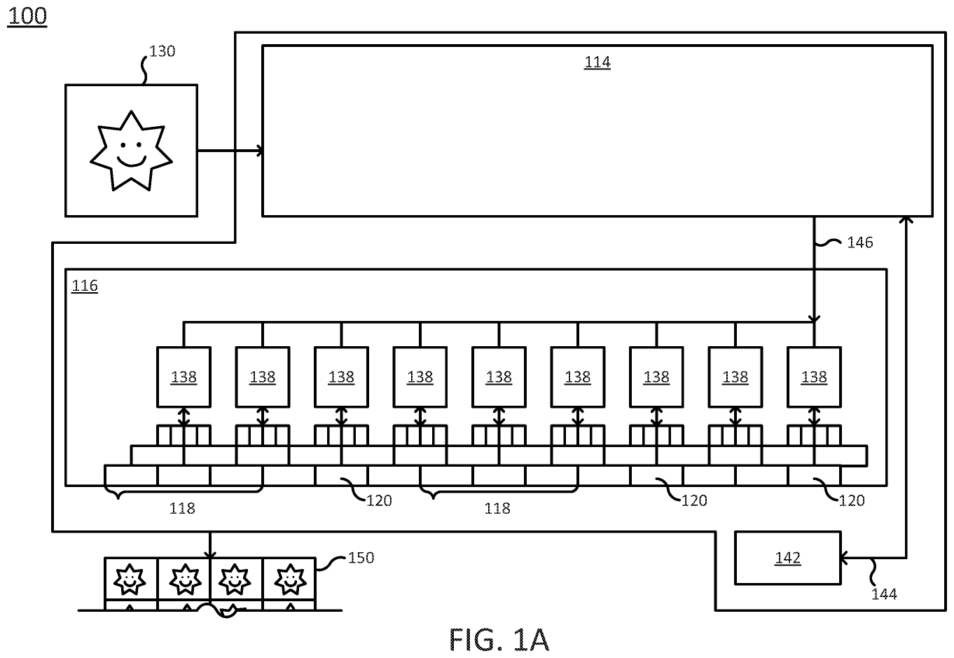

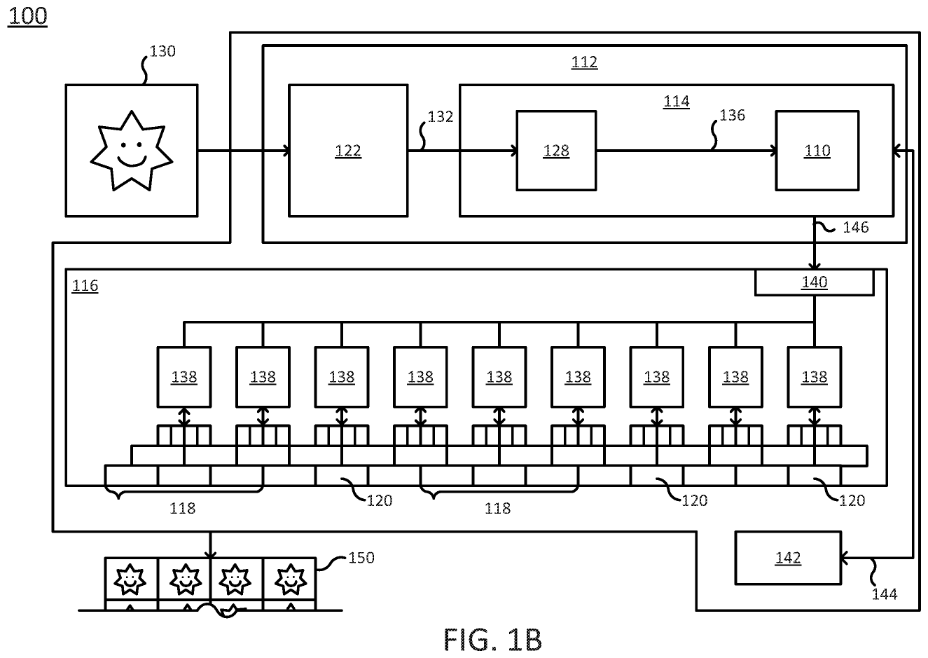

FIG. 1A illustrates a first example system 100 of the present disclosure. In one example, the system 100 is a packaging web press (PWP). The system 100 generally includes a controller 114, a plurality of nozzles implemented as a print engine 116, and a vision system 142. The image processing system 112, print engine 116, and vision system 142 work together to convert original image data 130 for an image (e.g., a digital image) into a print output 150 that may comprise repeating instances of the image.

In one example, the controller 114 is a print engine controller. Thus, the controller 114 may include a halftoning module, a colors-to-fluid conversion module, or other modules, as discussed in greater detail below. The controller 114 generates data that may be used to drive elements of the print engine 116 to produce a printed image or object. Although the controller 114 is illustrated as an internal component of the system 100, some printer engine controller functions may be performed outside of the system 100. Thus, the system illustrated in FIG. 1A shows only one example configuration that may be used to implement the functionality of the controller 114.

In one example, the print engine 116 is implemented as a modular fluid ejection array (e.g., print bar) that includes a plurality of fluid ejection modules 118, each of which is controlled by a respective fluid ejection array controller 138. Each fluid ejection module 118, in turn, includes a plurality of fluid ejection devices (e.g., print heads) 120. The fluid ejection devices 120 may be of the type used in high-speed commercial packaging web presses. For instance, the fluid ejection devices 120 may each include a plurality of nozzles. The fluid ejection devices 120 are driven by data produced by the controller 114.

The vision system 142 monitors the print output 150. To this end, the vision system 142 may include an image capturing device and a communication device for sending signals 144 to the controller 114. The vision system 142 may be communicatively coupled (e.g., indirectly) to the fluid ejection array controllers 138 (e.g., individually, or as a group). The vision system 142 captures images of the print output 150 and evaluates these images in order to detect visual discontinuities in the print output 150 (e.g., voids due to nozzle damage or blockage). The vision system 142 may further identify a faulty nozzle that is responsible for the visual discontinuities. This information is sent back to the controller 114, which in turn may identify a candidate alternate nozzle to fire in place of the faulty nozzle. The controller 114 may further identify a specific time at which to cease firing the faulty nozzle and commence firing the alternate nozzle in its place, such that further discontinuities in the print output 150 can be minimized. To this end, the controller 114 may include or have access to a memory to store one or more masks that cause different groups of nozzles to fire.

The signals 146 that the print engine controller 114 sends to the fluid ejection array controllers 138 may include instructions to specific fluid ejection array controllers 138. These instructions may command the fluid ejection array controllers 138 to cease or commence firing specific nozzles at specific times. The instructions may identify these specific nozzles individually or may include an identifier of a mask that identifies groups of firing and non-firing nozzles on the associated fluid ejection device.

FIG. 1B illustrates a second example system 100 of the present disclosure. The system 100 is a more detailed version of the system 100 illustrated in FIG. 1A. As such, the same reference numerals are used to indicate the same components. In one example, the system 100 is a packaging web press (PWP). The system 100 generally includes an image processing system 112, a print engine 116, and a vision system 142. The image processing system 112, print engine 116, and vision system 142 work together to convert original image data 130 for an image (e.g., a digital image) into a print output 150 that may comprise repeating instances of the image.

In one example, the image processing system 112 further comprises a raster image processor (RIP) 122 and a print engine controller 114. The RIP 122 converts the page description language (PDL) describing the original image data 130 to rasterized (e.g., pixelated) image data 132. The RIP 122 may be implemented as a distinct programming element or as part of an integrated program or programming element to perform specified functions. Furthermore, the RIP 122 may include a processor and/or other electronic circuitry and components to execute the programming (i.e., executable instructions) to perform the specified functions. In some examples, the RIP 122 may comprise a combination of hardware and programming to implement the functionalities of the RIP 122.

The print engine controller 114 includes a halftoning module 128 and a colors-to-fluid conversion module 110. In another example, the halftoning module 128 may reside on the RIP 122. The halftoning module 128 receives continuous tone (“contone”) rasterized image data 132 from the RIP 122 and converts it to halftone data 136. Conversion to halftone data 136 includes approximating continuous tone colors with a limited number of available discrete colors. For instance, the colors that the system 100 cannot print directly may be simulated using patterns of pixels in the colors that are available. The halftoning module 128 may perform any one or more halftoning techniques to perform this conversion.

The colors-to-fluid conversion module 110 receives the halftone data 136 and maps the halftone data 136 to drops of fluid (e.g., printing fluid such as ink, toner, a detailing agent, or the like) to be generated by the fluid ejection devices 120. This information may be used to drive the fluid ejection devices 120 to produce a printed image or object.

Either or both of the halftoning module 128 and the colors-to-fluid conversion module 110 may be implemented as a distinct programming element or as part of an integrated program or programming element to perform specified functions. Furthermore, either or both of the halftoning module 128 and the colors-to-fluid conversion module 110 may include a processor and/or other electronic circuitry and components to execute the programming (i.e., executable instructions) to perform the specified functions.

Moreover, although the print engine controller 114 is illustrated as an internal component of the system 100, some printer controller functions may be performed outside of the system 100. Thus, the system illustrated in FIG. 1B shows only one example configuration that may be used to implement the functionality of the halftoning module 128 and the colors-to-fluid conversion module 110.

In one example, the print engine 116 is implemented as a modular fluid ejection array (e.g., print bar) that includes a plurality of fluid ejection modules 118, each of which is controlled by a respective fluid ejection array controller 138. Each fluid ejection module 118, in turn, includes a plurality of fluid ejection devices (e.g., print heads) 120. The fluid ejection devices 120 may be of the type used in high-speed commercial packaging web presses. For instance, the fluid ejection devices 120 may each include a plurality of nozzles. The fluid ejection devices 120 are driven by the halftone data 136 produced by the halftoning module 128, for instance at one or two bits of data per pixel in each color plane. In this example, the print engine controller 114 passes instructions to the print engine 116 via a fluid ejection array interface 140.

The vision system 142 monitors the print output 150. To this end, the vision system 142 may include an image capturing device and a communication device for sending signals 144 to the image processing system 112 (e.g., to the print engine controller 114 of the image processing system 112). The image processing system 112 controls one or more of the fluid ejection array controllers 138. The vision system 142 may thus be communicatively coupled (e.g., indirectly) to the fluid ejection array controllers 138 (e.g., individually, or as a group). The vision system 142 captures images of the print output 150 and evaluates these images in order to detect visual discontinuities in the print output 150 (e.g., voids due to nozzle damage or blockage). The vision system 142 may further identify a faulty nozzle that is responsible for the visual discontinuities. This information is sent back to the print engine controller 114, which in turn may identify a candidate alternate nozzle to fire in place of the faulty nozzle. The print engine controller 114 may further identify a specific time at which to cease firing the faulty nozzle and commence firing the alternate nozzle in its place, such that further discontinuities in the print output 150 can be minimized. To this end, the print engine controller 114 may include or have access to a memory to store one or more masks that cause different groups of nozzles to fire.

The signals 146 that the print engine controller 114 sends to the fluid ejection array controllers 138 (e.g., via the fluid ejection array interface 140) may include instructions to specific fluid ejection array controllers 138. These instructions may command the fluid ejection array controllers 138 to cease or commence firing specific nozzles at specific times. The instructions may identify these specific nozzles individually or may include an identifier of a mask that identifies groups of firing and non-firing nozzles on the associated fluid ejection device.

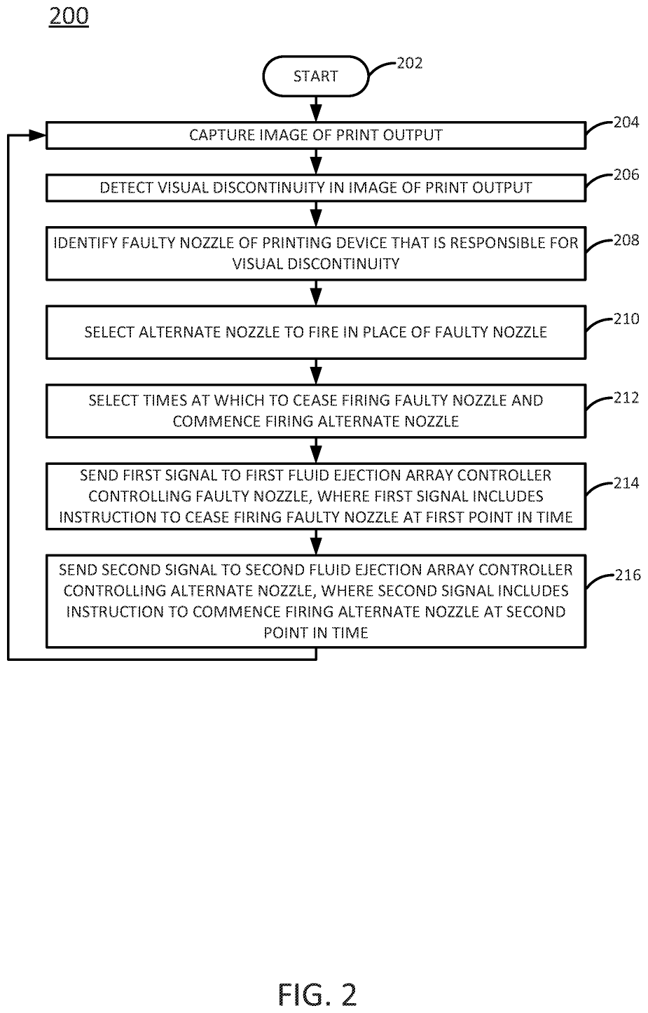

FIG. 2 illustrates a flowchart of an example method 200 for correcting visual discontinuities in print outputs. The method 200 may be performed, for example, by the system 100 illustrated in FIGS. 1A and 1B. As such, reference is made in the discussion of FIG. 2 to various components of the system 100 to facilitate understanding. However, the method 200 is not limited to implementation with the system illustrated in FIGS. 1A and 1B.

The method 200 begins in block 202. In block 204, the vision system 142 captures an image of the system's print output 150. The print output 150 may comprise at least one repeating image printed on a web.

In block 206, the vision system 142 detects a visual discontinuity in the image of the print output 150. The visual discontinuity may comprise, for example, a void caused by a faulty nozzle that is damaged or blocked or otherwise not firing properly.

In block 208, the vision system 142 identifies the faulty nozzle that is responsible for the visual discontinuity. For instance, the vision system 142 may identify the specific fluid ejection device on which the faulty nozzle is located, as well as the location of the faulty nozzle on the specific fluid ejection device. Identification of the faulty nozzle may be facilitated by the location of the visual discontinuity in the print output 150.

In block 210, the print engine controller 114, based on the identification of the visual discontinuity and the faulty nozzle by the vision system 142, selects an alternate nozzle to fire in place of the faulty nozzle. The alternate nozzle is a nozzle that, if fired at a particular time and/or speed, can produce or approximate with sufficient quality the print output that the faulty nozzle would have produced if it were firing properly. In one example, the alternate nozzle is a nozzle that is currently firing to produce the print output 150 (e.g., to maximize the speed of the system 100). In another example, the alternate nozzle is a nozzle that is not currently firing to produce the print output 150 (e.g., is currently idle).

In block 212, the print engine controller 114 selects times at which to cease firing the faulty nozzle and commence firing the alternate nozzle in its place. For instance, if the time at which the switch from the faulty nozzle to the alternate nozzle is not selected carefully, the switch may result in further visual discontinuities in the print output 150, especially if the alternate nozzle is already currently firing. Thus, the print engine controller 114 may elect to wait until a time is available where the switch can be made in a manner that minimizes further visual discontinuities. For instance the print engine controller 114 may elect to wait until the system 100 reaches a frame boundary (e.g., between pages) of the web, until a splice event, or until a job change. For multi-lane PWPs, the frame boundary may be different than the page boundary; thus the print engine controller 114 may perform additional computations in order to determine an appropriate time for the switch.

In block 214, the print engine controller 114 sends a first signal to a first fluid ejection array controller 138 that controls the fluid ejection device 120 on which the faulty nozzle is located. The first signal includes an instruction to cease firing the faulty nozzle at a first point in time.

In block 216, the print engine controller 114 sends a second signal to a second fluid ejection array controller 138 that controls the fluid ejection device 120 on which the alternate nozzle is located. The second signal includes an instruction to commence firing the alternate nozzle at a second point in time. The second point in time may be the same as the first point in time, or it may be a different point in time. It should be noted that the faulty nozzle and the alternate nozzle may be controlled by the same fluid ejection array controller 138 (due to the inclusion of redundant nozzles) or by different fluid ejection array controllers 138. Thus, in some cases, the first fluid ejection array controller 138 and the second fluid ejection array controller 138 may comprise the same fluid ejection array controller 138.

The method 200 then returns to block 204 and continues as described above to monitor the print output 150 for visual discontinuities.

In further examples, the techniques of the present disclosure can be applied in the realm of three-dimensional (3D) printing to improve part-to-part consistency. The control systems of a 3D printer, including the printing nozzles and positioning parameters, may exhibit unintentional variation, damage, blockage, and the like in the same way that the control systems of a PWP might. Examples of the present disclosure may also be applied to non-packaging web presses.

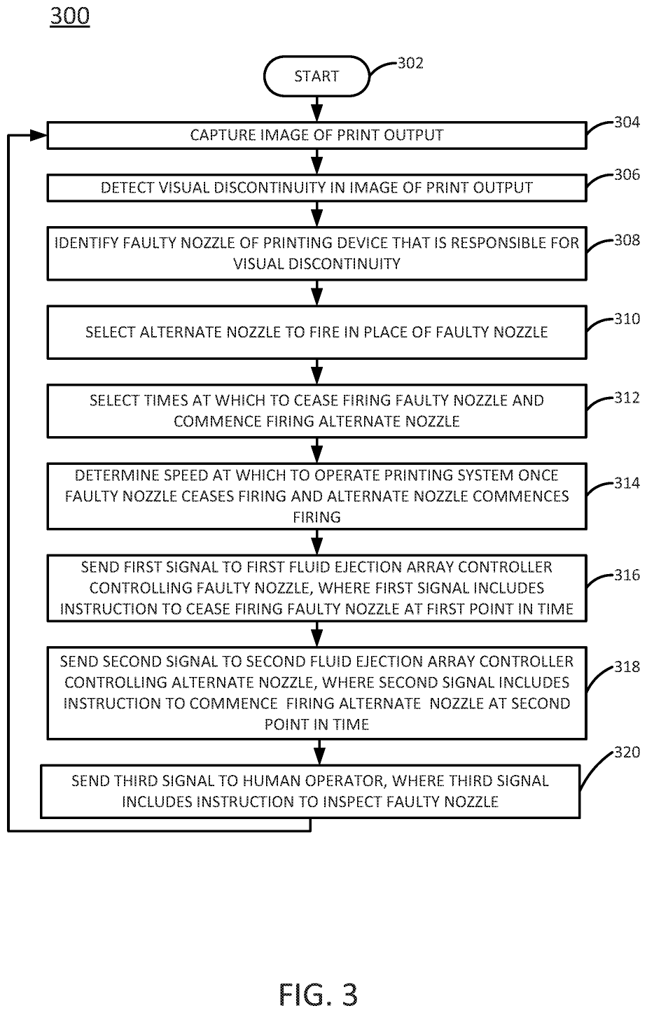

FIG. 3 illustrates a flowchart of another example method 300 for correcting visual discontinuities in print outputs. In particular, the method 300 represents a more detailed version of the method 200 illustrated in FIG. 2. As such, the method 300 may be performed, for example, by the system 100 illustrated in FIGS. 1A and 1B. Thus, reference is made in the discussion of FIG. 3 to various components of the system 100 to facilitate understanding. However, the method 300 is not limited to implementation with the system illustrated in FIGS. 1A and 1B.

The method 300 begins in block 302. In block 304, the vision system 142 captures an image of the print output 150. The print output 150 may comprise at least one repeating image printed on a web, as discussed above.

In block 306, the vision system 142 detects a visual discontinuity in the image of the print output 150. The visual discontinuity may comprise, for example, a void caused by a faulty nozzle that is damaged or blocked or otherwise not firing properly.

In block 308, the vision system 142 identifies the faulty nozzle that is responsible for the visual discontinuity, as discussed above.

In block 310, the print engine controller 114 selects an alternate nozzle to fire in place of the faulty nozzle, as discussed above.

In block 312, the print engine controller 114 selects times at which to cease firing the faulty nozzle and commence firing the alternate nozzle. As discussed above, the print engine controller 114 may elect to wait until a time is available where the switch can be made in a manner that minimizes further visual discontinuities, such as when the system 100 reaches a frame boundary (e.g., between pages) of the web, until a splice event, or until a job change.

In block 314, the print engine controller 114 determines a speed at which to operate the system 100 once the faulty nozzle ceases firing and the alternate nozzle commences firing in its place. As discussed above, some systems with redundant nozzles may fire all nozzles at once in order to maximize printing speed. In this case, when the alternate nozzle commences firing in place of the faulty nozzle, there will be less nozzles firing than were firing previously. Adjusting the speed of the system 100 (e.g., by slowing it down) may help to maintain consistent quality in the print output 150 despite the reduction in the number of firing nozzles. In some cases, however, the print engine controller 114 may elect to maintain the same operating speed for the system 100. In one example, the tradeoff between print output quality and print speed may be configurable by a user. For instance, the user may determine a minimum acceptable speed at which the system 100 may operate, regardless of print output quality.

In block 316, the print engine controller 114 sends a first signal to a first fluid ejection array controller 138 that controls the fluid ejection device 120 on which the faulty nozzle is located. The first signal includes an instruction to cease firing the faulty nozzle at a first point in time. The first signal may further include an instruction to adjust the speed at which the nozzles on the fluid ejection device 120 are fired.

In block 318, the print engine controller 114 sends a second signal to a second fluid ejection array controller 138 that controls the fluid ejection device 120 on which the alternate nozzle is located. The second signal includes an instruction to commence firing the alternate nozzle at a second point in time. The second point in time may be the same as the first point in time, or it may be a different point in time. The second signal may further include an instruction to adjust the speed at which the nozzles on the fluid ejection device 120 are fired.

In block 320, the vision system 142 sends a third signal instructing a human operator to inspect the faulty nozzle. The instruction thus lets a human operator know that the faulty nozzle is not firing properly, which allows the faulty nozzle to be inspected, repaired, and/or replaced as appropriate. The third signal may be sent to a remote device operated by the human operator (e.g., a remote computer, a smart phone, or the like) or may be sent to an alert mechanism on the system 100 that produces some sort of visual and/or audible alert to notify the human operator of the faulty nozzle.

The method 300 then returns to block 304 and continues as described above to monitor the print output 150 for visual discontinuities.

In some cases, the visual discontinuities in the print output 150 may be so severe that they cannot be corrected without stopping the system 100. For instance, if there are a large number of faulty nozzles, the system 100 may not be able to determine an appropriate set of alternate nozzles and/or an alternate print speed that will allow the system 100 to maintain an acceptable level of quality in the print output 150. In this case, the vision system 142 may send a signal to a controller of the system 100 to cease printing until the faulty nozzles can be repaired and/or replaced.

It should be noted that although not explicitly specified, some of the blocks, functions, or operations of the methods 200 and 300 described above may include storing, displaying and/or outputting for a particular application. In other words, any data, records, fields, and/or intermediate results discussed in the methods can be stored, displayed, and/or outputted to another device depending on the particular application. Furthermore, blocks, functions, or operations in FIGS. 2 and 3 that recite a determining operation, or involve a decision, do not necessarily imply that both branches of the determining operation are practiced. In other words, one of the branches of the determining operation can be deemed to be optional.

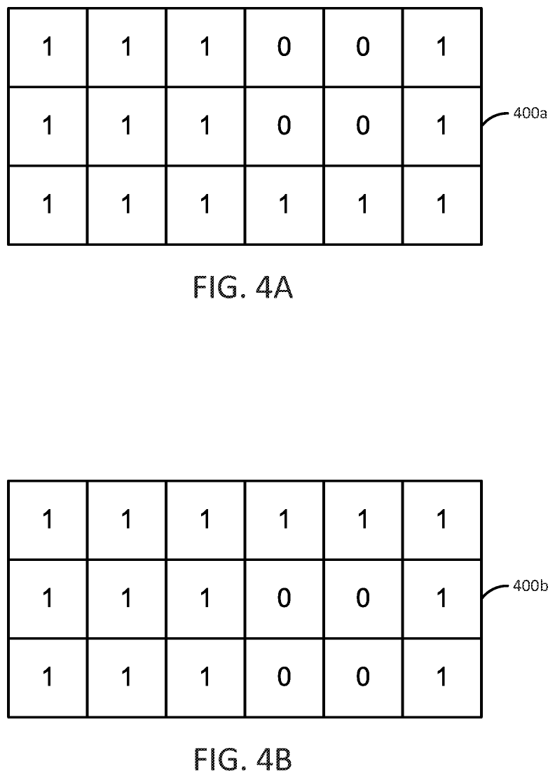

As discussed above, in some examples, masks may be used to control the replacement of firing nozzles. Masks are data structures that contain information about which nozzles should fire and should not fire at a given time. FIGS. 4A and 4B, for example, are block diagrams illustrating example masks 400a and 400b that may be used in conjunction with the above disclosed methods to facilitate correction of visual discontinuities in print outputs.

In one example, each mask 400a or 400b comprises a grid or other spatial construct that may be broken down into multiple discrete sections. The grid represents a fluid ejection device, and each space on the grid represents at least one nozzle on the fluid ejection device. A binary indicator may be placed in each space of the grid to indicate whether or not the nozzle associated with the space should fire. For instance, in the examples illustrated in FIGS. 4A and 4B, a one (1) indicates that the associated nozzle should fire, while a zero (0) indicates that the associated nozzle should not fire. A plurality of different preconfigured masks may be stored in a memory and may be accessible to the print engine controller 114 of the system 100. The print engine controller 114 may also create new masks on demand. Thus, rather than address individual nozzles when attempting to replace one or more faulty nozzles with alternate nozzles, the print engine controller 114 may instead identify or send a specific mask to the fluid ejection array controller 138. The fluid ejection array controller 138 will then fire the nozzles in accordance with the mask until instructed otherwise.

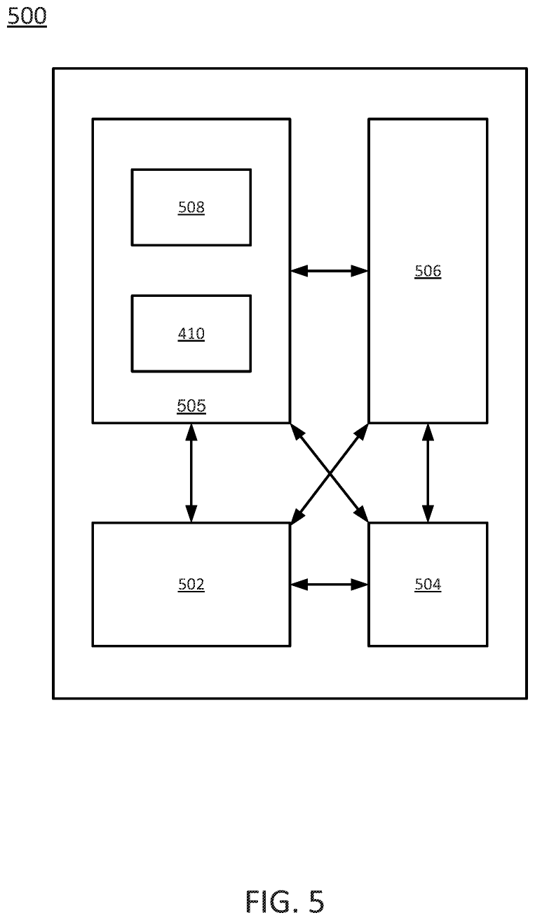

FIG. 5 depicts a high-level block diagram of an example computer 500 that can be transformed into a machine capable of performing the functions described herein (e.g., a visions system such as vision system 142). Notably, no computer or machine currently exists that performs the functions as described herein. As a result, the examples of the present disclosure modify the operation and functioning of the computer 500 to correct visual discontinuities in print outputs, as disclosed herein.

As depicted in FIG. 5, the computer 500 comprises a hardware processor element 502, e.g., a central processing unit (CPU), a microprocessor, or a multi-core processor, a memory 504, e.g., random access memory (RAM) and/or read only memory (ROM), a module 505 for correcting visual discontinuities in print outputs, and various input/output devices 506, e.g., storage devices, including but not limited to, a tape drive, a floppy drive, a hard disk drive or a compact disk drive, a receiver, a transmitter, a speaker, a display, an image capturing device, a speech synthesizer, an output port, an input port and a user input device, such as a keyboard, a keypad, a mouse, a microphone, and the like.

Although one processor element is shown, it should be noted that the computer 500 may employ a plurality of processor elements. Furthermore, although one computer 500 is shown in the figure, if the method(s) as discussed above is implemented in a distributed or parallel manner fora particular illustrative example, i.e., the blocks of the above method(s) or the entire method(s) are implemented across multiple or parallel computers, then the computer 500 of this figure is intended to represent each of those multiple general-purpose computers. Furthermore, a hardware processor can be utilized in supporting a virtualized or shared computing environment. The virtualized computing environment may support a virtual machine representing computers, servers, or other computing devices. In such virtualized virtual machines, hardware components such as hardware processors and computer-readable storage devices may be virtualized or logically represented.

It should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the blocks, functions and/or operations of the above disclosed methods.

In one example, instructions and data for the present module or process 505 for correcting visual discontinuities in print outputs, e.g., machine readable instructions can be loaded into memory 504 and executed by hardware processor element 502 to implement the blocks, functions or operations as discussed above in connection with the methods 200 and 300. For instance, the module 505 may include a plurality of programming code components, including a detection component 508 and a selection component 510. These programming code components may be included, for example, in a vision system, such as the vision system 142 of FIGS. 1A and 1B.

The detection component 408 may be configured to identify visual discontinuities (e.g., voids) in a print output. For instance, the detection component 508 may be configured to perform all or part of blocks 206 and 306 of the methods 200 and 300, respectively.

The selection component 510 may be configured to identify a faulty nozzle or nozzles responsible for a detected visual discontinuity and to select an alternate nozzle or nozzles to fire in place of the faulty nozzle(s). The selection component 510 may be further configured to select the timing of the switch from the faulty nozzle to the alternate nozzle and/or to select a printing system speed to accommodate the switch. For instance, the selection component 510 may be configured to perform blocks 206-210 of the method 200 or blocks 306-312 of the method 300.

Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the above described method(s) can be perceived as a programmed processor or a specialized processor. As such, the present module 505 for correcting visual discontinuities in print outputs, including associated data structures, of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. A system, comprising:
a plurality of nozzles to eject fluid that creates an output;
a vision system to detect a visual discontinuity in the output and to identify a faulty nozzle of the plurality of nozzles that is a source of the visual discontinuity;
a controller to select an alternate nozzle of the plurality of nozzles to eject fluid in place of the faulty nozzle to minimize the visual discontinuity, and to select a time at which the faulty nozzle ceases ejecting fluid and the alternate nozzle commences ejecting fluid in place of the faulty nozzle to minimize the visual discontinuity; and
a fluid ejection array controller connected to the plurality of nozzles and to the controller, to control ejection of fluid by the faulty nozzle and the alternate nozzle under an instruction from the controller.

2. The system of claim 1, wherein the system is a packaging web press, and the plurality of nozzles is arranged on a print head of the packaging web press.

3. The system of claim 1, wherein fluid ejection system is further to control a speed of the ejection of fluid under an instruction from the controller.

4. The system of claim 1, further comprises:
a memory accessible to the controller to store a mask, wherein the mask comprises a data structure representing a fluid ejection device on which a subset of the plurality of nozzles is located, and the mask indicates which nozzles of the subset eject fluid and which nozzles of the subset do not eject fluid.

5. The system of claim 1, further comprising:
an alert mechanism to notify a human operator of the faulty nozzle.

6. A non-transitory machine-readable storage medium encoded with instructions executable by a processor, the machine-readable storage medium comprising:
instructions to detect a visual discontinuity in a print output;
instructions to identify a faulty nozzle of a fluid ejection device that is responsible for the visual discontinuity;
instructions to select an alternate nozzle to eject fluid in place of the faulty nozzle;
instructions to select a first time at which to cease ejection of fluid by the faulty nozzle and a second time at which to commence ejecting fluid by the alternate nozzle acting in place of the faulty nozzle;
instructions to send a first signal to a first fluid ejection array controller controlling the faulty nozzle, wherein the first signal instructs the first fluid ejection array controller to cease ejection of fluid by the faulty nozzle at the first time; and
instructions to send a second signal to a second fluid ejection array controller controlling the alternate nozzle, wherein the second signal instructs the second fluid ejection array controller to commence ejection of fluid by the alternate nozzle acting in place of the faulty nozzle at the second time.

7. The non-transitory machine-readable storage medium of claim 6, further comprising:
instructions to select a speed at which to operate a system producing the output to minimize the visual discontinuity when the faulty nozzle ceases ejecting fluid and the alternate nozzle commends ejecting fluid in place of the faulty nozzle.

8. The non-transitory machine-readable storage medium of claim 6, wherein the speed is slower than a speed at which the system is currently operating.

9. The non-transitory machine-readable storage medium of claim 6, wherein the first signal includes an identification of a mask, wherein the mask comprises a data structure representing a fluid ejection device controlled by the fluid ejection array controller, and the mask indicates which nozzles of the fluid ejection device eject fluid and which nozzles of the fluid ejection device do not eject fluid.

10. The non-transitory machine-readable storage medium of claim 6, wherein the first time comprises a time at which a system producing the output reaches a frame boundary of the output.

11. The non-transitory machine-readable storage medium of claim 6, wherein the first time comprises a time at which a system producing the output reaches a splice event.

12. The non-transitory machine-readable storage medium of claim 6, wherein the first time comprises a time at which a system producing the output changes jobs.

13. The non-transitory machine-readable storage medium of claim 6, wherein an implementation of the first signal by the first fluid ejection array controller and an implementation of the second signal by the second fluid ejection array controller results in a reduced number of nozzles ejecting fluid relative to a number of nozzles currently ejecting fluid.

14. A method, comprising:
detecting a visual discontinuity in a print output;
identifying a faulty nozzle of a fluid ejection device that is responsible for the visual discontinuity;
selecting an alternate nozzle to eject fluid in place of the faulty nozzle;
selecting a first time at which to cease ejection of fluid by the faulty nozzle and a second time at which to commence ejecting fluid by the alternate nozzle acting in place of the faulty nozzle;
sending a first signal to a first fluid ejection array controller controlling the faulty nozzle, wherein the first signal instructs the first fluid ejection array controller to cease ejection of fluid by the faulty nozzle at the first time; and
sending a second signal to a second fluid ejection array controller controlling the alternate nozzle, wherein the second signal instructs the second fluid ejection array controller to commence ejection of fluid by the alternate nozzle acting in place of the faulty nozzle at the second time.

15. The method of claim 14, further comprising:
selecting a speed at which to operate a system producing the output to minimize the visual discontinuity when the faulty nozzle ceases ejecting fluid and the alternate nozzle commends ejecting fluid in place of the faulty nozzle.
